(19) United States
(12) Patent Application Publication
(10) Pub. No.: US 2002/0188670 A1
(43) Pub. Date: Dec. 12, 2002

(54) Method and apparatus that enables language translation of an electronic mail message

(76) Inventor: Gary G. Stringham, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/877,913

(22) Filed: Jun. 8, 2001

(51) Int. Cl. G06F 17/28; G06F 15/16

(52) U.S. Cl. 709/203; 704/5

(57) ABSTRACT

An e-mail program enables automated or user-selected language translation of an e-mail message. The e-mail program may include a set of databases having data fields for storing information that identifies a language in which a user writes e-mail messages and for storing information that identifies a language in which one or more potential correspondents write e-mail messages. For each incoming and outgoing e-mail message, the language of the user is compared to the language used by a designated correspondent from whom the e-mail message was sent or to whom the e-mail message shall be transmitted. If the languages are identical, no translation is performed. If instead the languages are different, the e-mail message is translated and then forwarded to the designated correspondent or, if received by the user, then stored in the user's e-mail inbox. The language translation may be performed using language translation software that is incorporated into the e-mail program, or via a web-based translation service, or using language translation software that is not incorporated into the e-mail program but that is accessible to a processor that executes the e-mail program 14.

The present invention generally relates to an electronic mail (“e-mail”) program, and more particularly to an e-mail program having a language translation feature that enables automated or user-selected translation of an e-mail message from a first language to a second language.

Due to the recent boom in electronic communication, the global community is becoming more accessible to the computer user. In particular, the increased usage of e-mail software programs have made communication between geographically distant places a common occurrence that can be performed with the click of a computer mouse. Moreover, e-mail programs are typically simple to operate and enable high-speed communication thereby making e-mail an efficient and often preferred form of communication for many users and businesses.

Unfortunately though, e-mail software programs are of limited value for effecting communication between users who communicate in different languages. In particular, conventional e-mail software programs do not enable e-mail message translation from a first language to a second language. Thus, although a user may send an e-mail message drafted in English to a correspondent who understands Spanish but not English, the Spanish correspondent will only be able to read the e-mail message after it has been translated to Spanish. As a result, the foreign language e-mail message may be entirely useless to the Spanish correspondent or, at a minimum, require that the Spanish correspondent have the e-mail message translated. Of course, the e-mail message may be translated by a person who performs language translation services, but locating and enlisting the services of a person with such skills can be a time consuming and costly process. Moreover, employing a person with language translation skills each time an e-mail message requires translation reduces the efficiency associated with using an e-mail software program to communicate.

Alternatively, the e-mail message may be translated using a software program having language translation capabilities. Although language translation software applications are not typically as accurate as persons skilled in language translation, language translation software tools are an attractive alternative for many computer users because the software may be used immediately upon receiving or generating an e-mail message to instantly perform translation. As a result, the translation is performed more quickly because the need to spend time locating and employing a person with language translation skills is eliminated.

Unfortunately, if a user opts to employ a language translation software application to translate e-mails, the software program must be installed on the user's computer and the user must learn how to operate the language translation software. Moreover, when language translation software is used to translate e-mail messages, the previously one-step method of receiving or sending an e-mail is converted into a multiple step process. The multiple step process may include steps such as, receiving/opening the e-mail message, storing the e-mail message in a memory located in the user's computer, launching the language translation software, supplying the e-mail message to the translation software and causing the e-mail translation software to translate the message. Although performing such steps may not take much time, less computer-savvy users often view having to learn new software as an intimidating task to be avoided. In addition, many computer users are accustomed to using only a few software applications for performing a plurality of daily tasks and often view having to launch another application as a nuisance. For example, some e-mail software programs allow a user to maintain an address book for storing data about a set of correspondents, i.e., a set of people or entities with whom the user corresponds. Other e-mail programs provide the user with an electronic calendar in which the user may store information concerning upcoming events. Still other e-mail programs allow users to track a set of impending deadlines associated with a set of projects. As a result, computer users are becoming increasingly dependent on the convenience afforded by integrated software applications that are able to perform a myriad of daily tasks.

Thus, there is a need in the art for a method and apparatus that enable a user to translate an e-mail message from a first language to a second language without additionally requiring that the user launch multiple software applications.

### BRIEF DESCRIPTION OF THE DRAWINGS

FIG. 1 is a block diagram of a computer used to store and execute an e-mail software program having a language translation feature according to the present invention;

FIGS. 2A, 2B, 2C and 2D are block diagrams of e-mail databases configured to store information that may be used to enable the language translation feature according to the present invention;

FIG. 3 is a flow chart of a method for enabling an automated language translation feature that translates an e-mail message before transmitting the e-mail message to a designated correspondent according to the present invention;

FIG. 4 is a flow chart of a method for enabling an automated language translation feature that translates an e-mail message after receiving the e-mail message from a correspondent according to the present invention;

FIG. 5 is a diagram of a dialog window that may be generated during the method of FIG. 3;

FIG. 6 is a flow chart of a method for enabling a user-selected language translation feature that translates an outgoing e-mail message according to the present invention;

FIG. 7 is a diagram of a dialog window that may be generated during the method of FIG. 6; and,

FIG. 8 is flow chart of a method for enabling a user-selected language translation features that translates an incoming e-mail message according to the present invention.

### SUMMARY OF THE INVENTION

The present invention is directed to an e-mail program that enables automated and/or user-selected language translation of an e-mail message. The e-mail program may include language translation software incorporated into the e-mail program for performing the translation, may automatically forward the e-message mail to a web-based translation service for translation or may interact with language translation software that performs the translation and that is either stored on the same computer as the e-mail program or that is accessible to the computer via, for example, a communication network.

### DETAILED DESCRIPTION

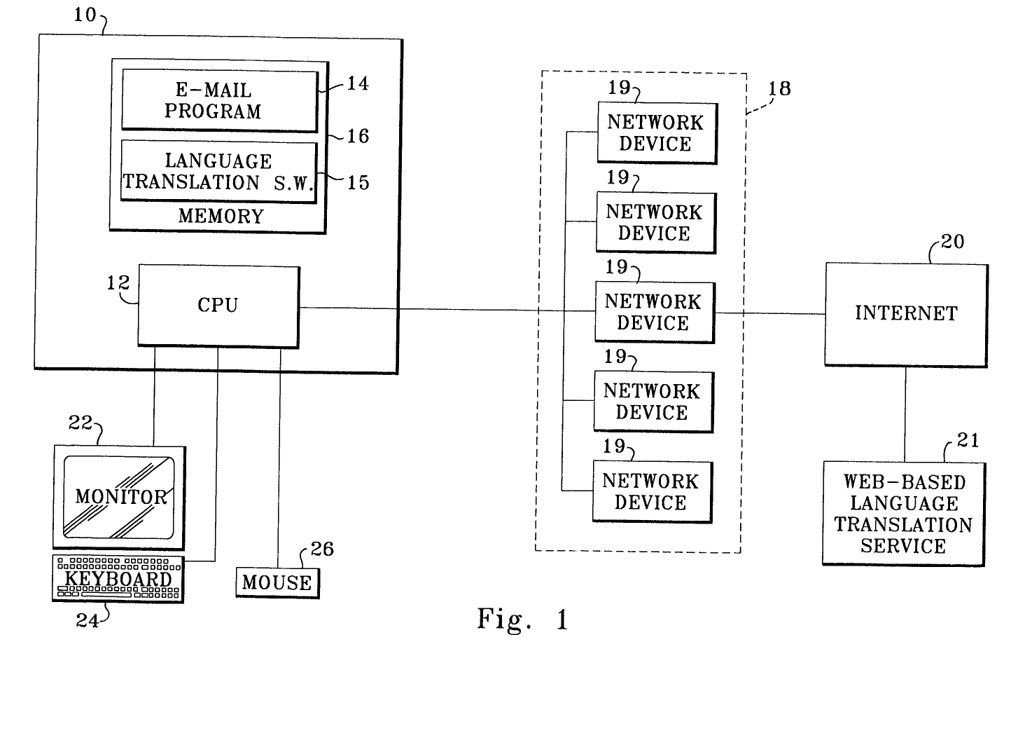

Referring now to FIG. 1, a computer 10 includes a central processing unit (CPU) 12 adapted to execute an e-mail software program 14 that enables automated and/or user-selected language translation and that is stored in a memory 16. The e-mail software program 14 may be capable of performing the language translation or may cause a language translation software application 15 that is also stored in the memory 16 to perform the language translation. Alternatively, the language translation software may be stored on any of a plurality of network devices 19, such as, for example, other computers, memory devices, or printers, that are coupled to the CPU 12 via a network 18. In addition, the network 18 is further coupled to the Internet 20 via any known connection including a telephone modem or a DSL connection, and thus may provide the computer with access to a web-based language translation service 21. A monitor 22, keyboard 24 and mouse 26 enable communication between a user and the CPU 12. Although not shown in FIG. 1, the computer 10 may further include any number of peripheral devices, for example, a modem, a sound card, a video card, etc.

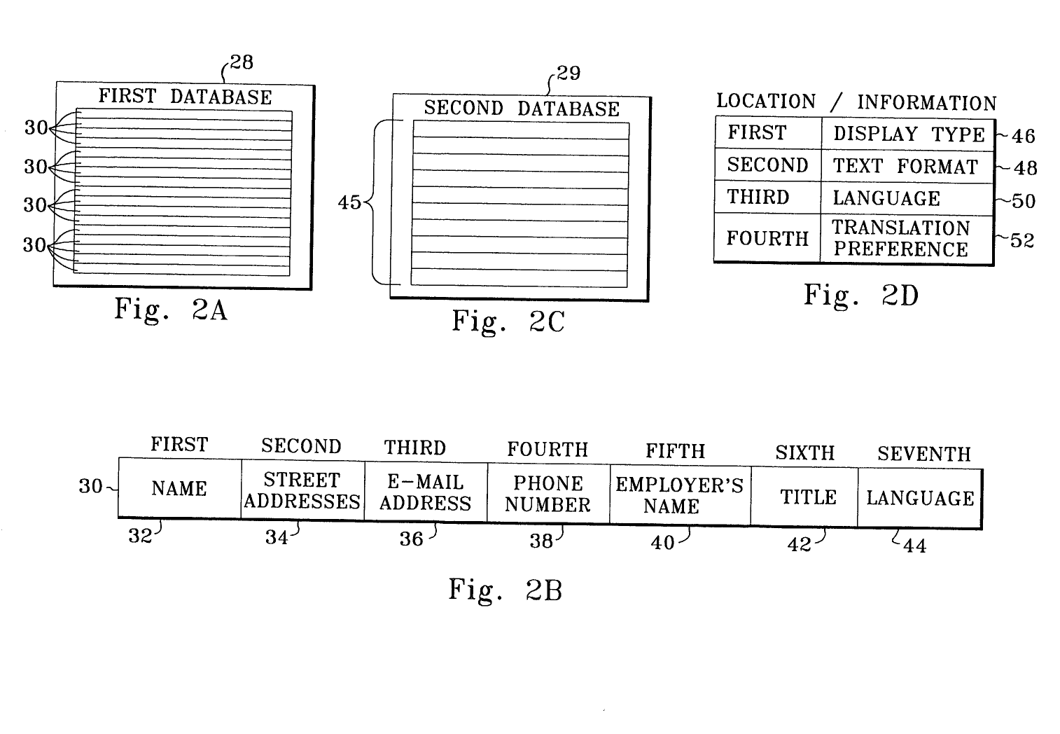

Referring now to FIGS. 2A, 2B, 2C and 2D, the e-mail software program 14 includes a set of first and second databases 28, 29 in which the user may store a variety of information for use by the e-mail software program 14. For example, the user may store information concerning a set of potential e-mail correspondents in the first database 28 which may be organized to include a set of locations 30 that are each associated with one of the potential e-mail correspondents. Each location 30 may further be organized to include a set of fields 32-44, wherein each field may be designated to store information of a particular type. Specifically, each location 30 in the first database 28 may include, for example, a first data field 32 for storing the name of an associated correspondent, a second data field 34 for storing the street address of the associated correspondent, a third data field 36 for storing the e-mail address of the associated correspondent, a fourth data field 38 for storing the phone number of the associated correspondent, a fifth data field 40 for storing the name of the associated correspondent's employer, and a sixth data field 42 for storing the associated correspondent's title. As will be understood by one having ordinary skill in the art, e-mail programs configured to store and maintain information of this nature are commercially available. For example, one such commercially available e-mail program, Microsoft® Outlook®, allows a user to store and maintain information concerning a set of potential correspondents referred to as “Contacts” and includes fields for storing the above-identified information for each contact. In addition to the first through sixth fields 32-42, each location 30 in the first database 28 may further include a seventh data field 44 for storing information that identifies the language used by the associated correspondent to write e-mail messages. If, for example, the associated correspondent writes his messages in English, then the seventh data field 44 will be used to store information that identifies English as the language of the associated correspondent.

Referring still to FIGS. 2A, 2B, 2C and 2D, the second database 29 may include a set of locations 45 for storing information concerning the user. For example, the second database 29 may include a first location 46 for storing information regarding the type of display preferred by the user and a second location 48 for storing information regarding the format that the user prefers for e-mail messages. As will be recognized by one having ordinary skill in the art, e-mail programs that enable the storage and maintenance of this type of information are commercially available. In addition to the first and second locations, the second database 29 may further include a third location 50 for storing information that identifies a language in which the user prefers to draft e-mail messages, and a fourth location 52 for storing a translation preference by which the user may indicate whether the e-mail program 14 shall translate e-mail messages automatically in a manner that is transparent to the user, or whether the e-mail program 14 shall translate e-mail messages only in response to a command that is entered by the user. The command may be entered, for example, in response to a prompt generated by the e-mail program 14. Alternatively, the fourth location 52 may be used to disable the translation feature so that none of the user's e-mail messages are translated. Of course, one having ordinary skill in the art will recognize that the e-mail program 14 may not actually include the first and second databases 28, 29 but may instead include software code that causes the CPU 12 to designate an area in the memory 16 in which the database information shall be stored and the software code may further cause information entered by the user to be organized in location or data fields similar to those described above. Further, the databases 28, 29 may include any number of data fields and/or locations designated to store any desired information. As will be understood, the e-mail program preferably, but not necessarily, causes the CPU 12 to store the databases in the memory 16. Instead, the e-mail program 14 may cause the CPU 12 to store the databases 28, 29 in any memory device to which the CPU 12 is communicatably coupled, including, for example, a memory device associated with one of the network devices 19.

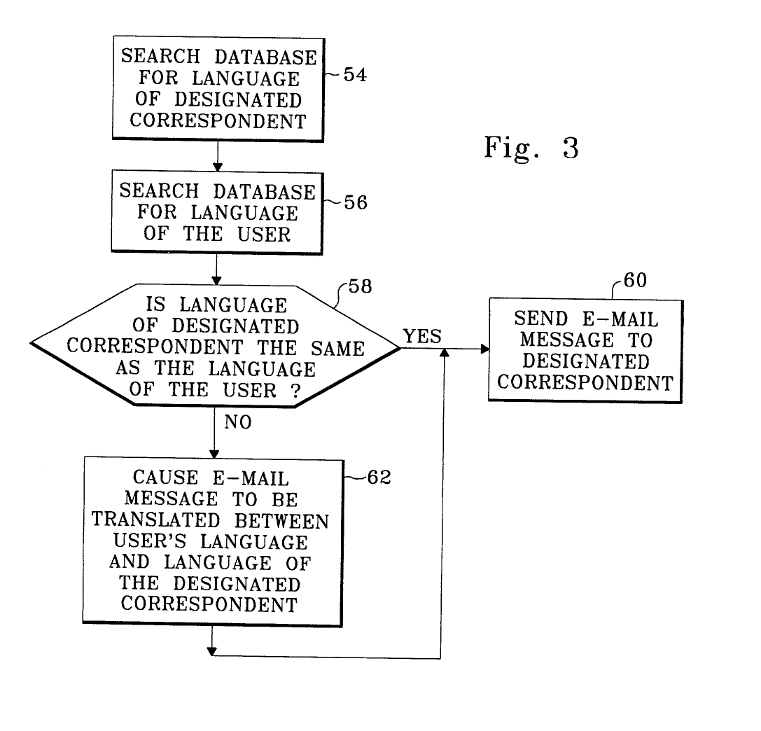

Referring now to FIG. 3, the e-mail program 14 may be implemented using, for example, software code that when executed by the CPU 12 or any other computer processor, causes a method for enabling automated translation of an e-mail message to be performed. More particularly, when the fourth location 52 of the second database 29 indicates that e-mail messages are to be translated automatically, the e-mail program 14 may cause the CPU 12 to perform the method illustrated by the flow chart of FIG. 3. Specifically, after drafting an e-mail message using the e-mail program 14 and upon prompting the e-mail program 14 to send the e-mail message to a designated correspondent, the e-mail program 14 accesses and searches the first database 28 to find the location 30 where information associated with the designated correspondent is stored and retrieves the name of the language used by the designated correspondent, i.e., the information contained in the seventh data field 44 (step 54).

After retrieving the name of the language spoken by the designated correspondent, the e-mail program 14 accesses and searches the second database 29 to locate and retrieve the language of the user, i.e., the information contained in the third location 50 (step 56). Next, the e-mail program 14 determines whether the user and designated correspondent use the same language by comparing the information in the third location 50 in the second database 29 to the information in the seventh data field 44 associated with the first database 28 (step 58). If the languages are the same, then language translation is not required and the e-mail program 14 causes the e-mail message to be transmitted to the designated correspondent (step 60) in an untranslated state. If instead the languages are not the same, then the e-mail program 14 causes the document to be translated from the language of the user to the language of the designated correspondent (step 62) and then causes the translated e-mail message to be sent to the designated correspondent (step 60) via the network 18.

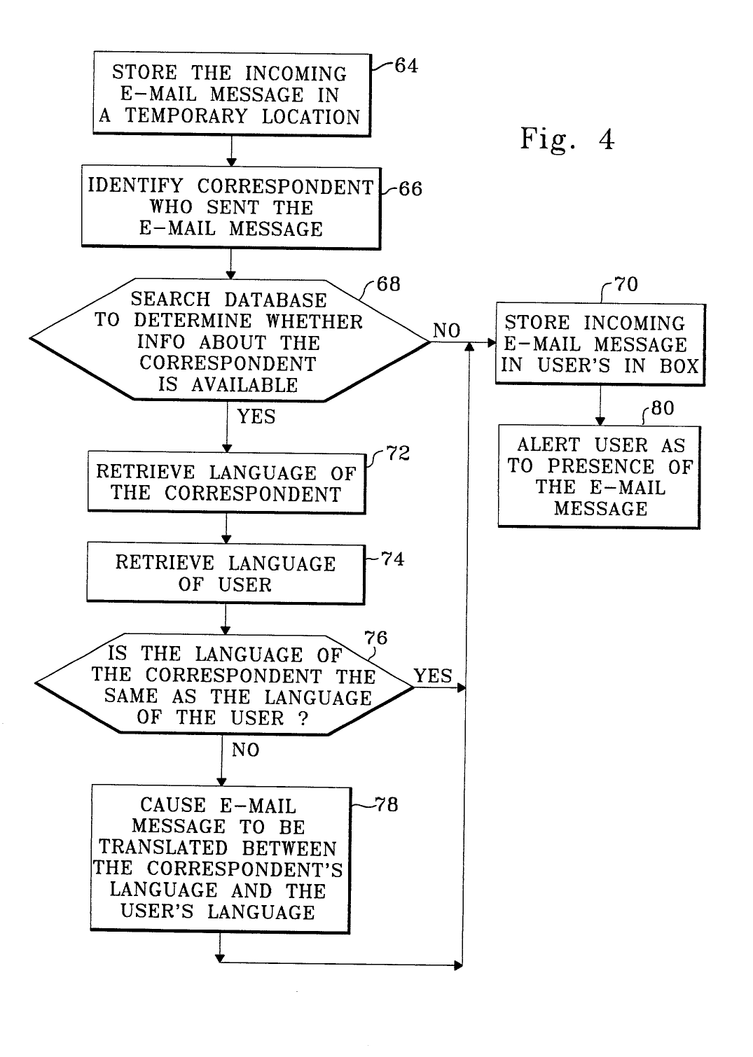

Referring also to FIG. 4, when an e-mail message is received at the computer 10 via, for example, the network 18 and the fourth location 52 in the database 29 indicates that translation shall be performed automatically, the e-mail program 14 may cause the CPU 12 to perform the method illustrated by the flow chart of FIG. 4. More particularly, the e-mail program 14 may cause the e-mail message to be stored in a temporary location in the memory 16 (step 64). After storing the e-mail message in the memory 16, the e-mail program 14 identifies the correspondent who sent the e-mail message (step 66) and then accesses the first database 28 to determine whether information concerning the correspondent is listed therein (step 68). If information concerning the correspondent is not listed therein, then the e-mail program 14 may cause the e-mail to be stored in the user's e-mail inbox (step 70) in an untranslated state. One having ordinary skill in the art will recognize that the user's e-mail inbox may constitute any memory repository where the e-mail program 14 causes all incoming e-mail messages to be stored for subsequent retrieval by the user. If instead information about the correspondent is stored in the first database 28, then the e-mail program 14 may retrieve the name of the language used by the correspondent from the first database 28 (step 72). In addition, the e-mail program 14 accesses the second database 29 and retrieves the language of the user (step 72). Upon retrieving both languages, the e-mail program 14 compares the languages to determine whether the language of the user is the same as the language used by the correspondent (step 76). If the languages are the same, then translation is not required and the e-mail program 14 causes the e-mail messages to be stored in the user's e-mail inbox (step 70) in an untranslated state and then alerts the user as to the presence of the e-mail message by displaying, for example, an alert message (step 80). If instead the languages are different, then the e-mail program 14 causes the e-mail message to be translated from the language used by the correspondent who sent the e-mail message to the language of the user (step 78). After the e-mail message has been translated, the e-mail program 14 causes the e-mail message to be stored in the user's e-mail inbox (step 70) and then, as described above, alerts the user as to the presence of the e3 mail message by displaying an alert message (step 80).

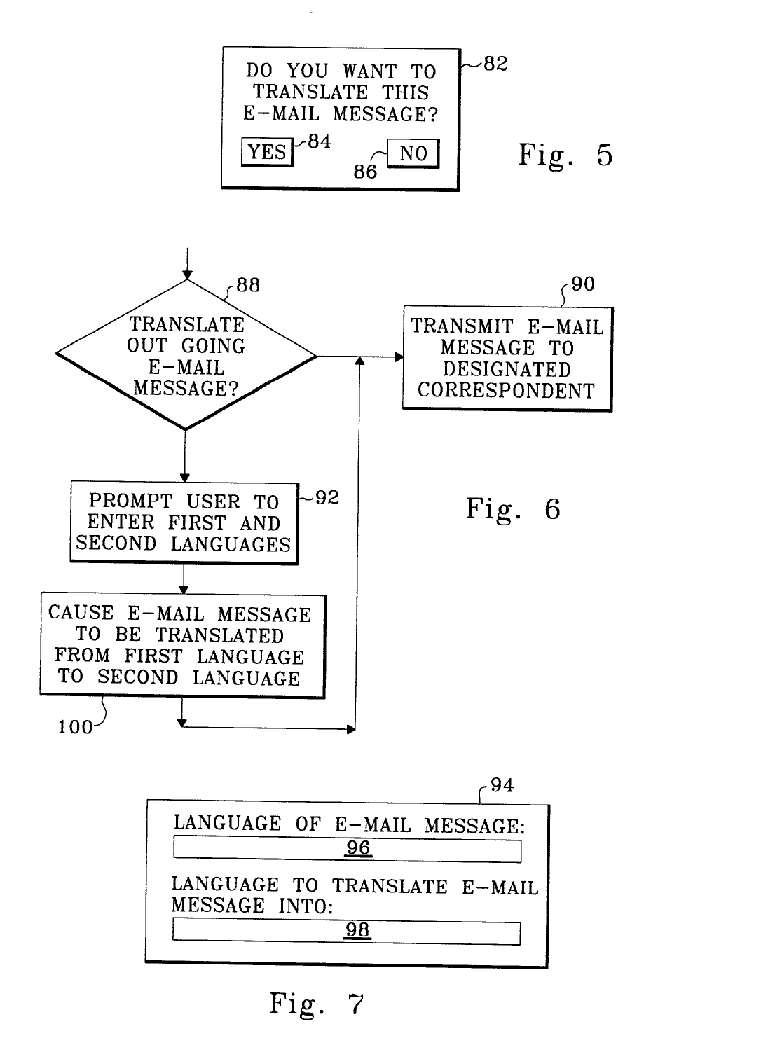

As described above, the methods illustrated in FIGS. 3 and 4 may be performed when the fourth location 52 of the second database 29 indicates that translation is to occur automatically thereby enabling the translation of e-mail messages in a manner that is transparent to the user. Alternatively, if the fourth location 52 in the second database 29 indicates that e-mail messages are to be translated only in response to a command entered by the user in response, for example, to a prompt generated by the e-mail program 14, then the method illustrated by the flow chart of FIG. 3 may be modified. More particularly, the method of FIG. 3 may be modified so that before the e-mail program 14 retrieves the language of the designated correspondent to whom the e-mail message is addressed, the e-mail program 14 prompts the user to indicate whether translation is desired. Referring also to FIG. 5, the e-mail program 14 may prompt the user by generating a dialog window 82 that asks whether language translation is desired and that may include, for example, two buttons 84, 86 that are selectable using the mouse 26 or keyboard 24. A first of the buttons 84 may be pressed if the user wants the message to be translated and a second of the buttons 86 may be pressed if the user does not want the message to be translated. If the user selects the first button 84, then the e-mail program 14 may cause the method of FIG. 3 to be performed (steps 54-60). If instead the user selects the second button 86, the e-mail program 14 does not translate the message but instead causes the e-mail message to be transmitted to the designated correspondent in an untranslated state (step 60). Likewise, the same dialog window 82 may be generated by the e-mail program 14 during the method illustrated in FIG. 4 to provide the user with control over whether e-mail messages are to be translated on a message-by-message basis. More particularly, the dialog window 82 may prompt the user to specify whether translation is desired at any time before the e-mail program 14 causes the e-mail message to be translated (before step 78) but preferably after storing the incoming e-mail message in the temporary memory location (after step 64). If the user selects the first button 84 of the dialog window 82, then the e-mail program 14 executes the steps necessary to translate the e-mail message (steps 66-68 and 72-78), stores the translated e-mail message in the user's e-mail inbox (step 70), and alerts the user as to presence of the translated e-mail message (step 80). Alternatively, if the user selects the second button 86 of the dialog window 82, then the e-mail program 14 causes the e-mail message to be stored in the user's e-mail inbox in an untranslated state (step 70) and alerts the user as to the presence of the e-mail message (step 80).

Referring now to FIG. 6, in an alternative embodiment, the e-mail program 14 need not include a set of memory locations 44, 50 for storing the names of the languages used by the potential correspondents and the user and may instead cause the CPU 12 to perform the method illustrated by the flow chart of FIG. 6. More particularly, after the user has prepared an e-mail message and has instructed the e-mail program 14 to transmit the e-mail message to a designated correspondent, the e-mail program 14 prompts the user to indicate whether translation is desired (step 88). For example, the e-mail program 14 may prompt the user by generating the dialog window 82 of FIG. 5 (step 88). If the user selects the second button 86 indicating that translation is not desired, then the e-mail program 14 causes the e-mail to be transmitted to the designated recipient (step 90) in an untranslated state. If instead the user selects the first button 84 indicating that translation is desired, then the e-mail program 14 prompts the user to enter a first language in which the e-mail message is written and a second language to which the e-mail shall be translated (step 92). For example, referring also to FIG. 7, the e-mail program 14 may prompt the user by generating a dialog window 94 having a first data entry field 96 designated for the language in which the e-mail message is written and a second data entry field 98 designated for the language to which the e-mail message shall be translated. After the user enters the languages at the dialog window 94, the e-mail program 14 causes the e-mail message to be translated in the manner specified (step 100) and the e-mail message is then transmitted to the designated correspondent (step 90).

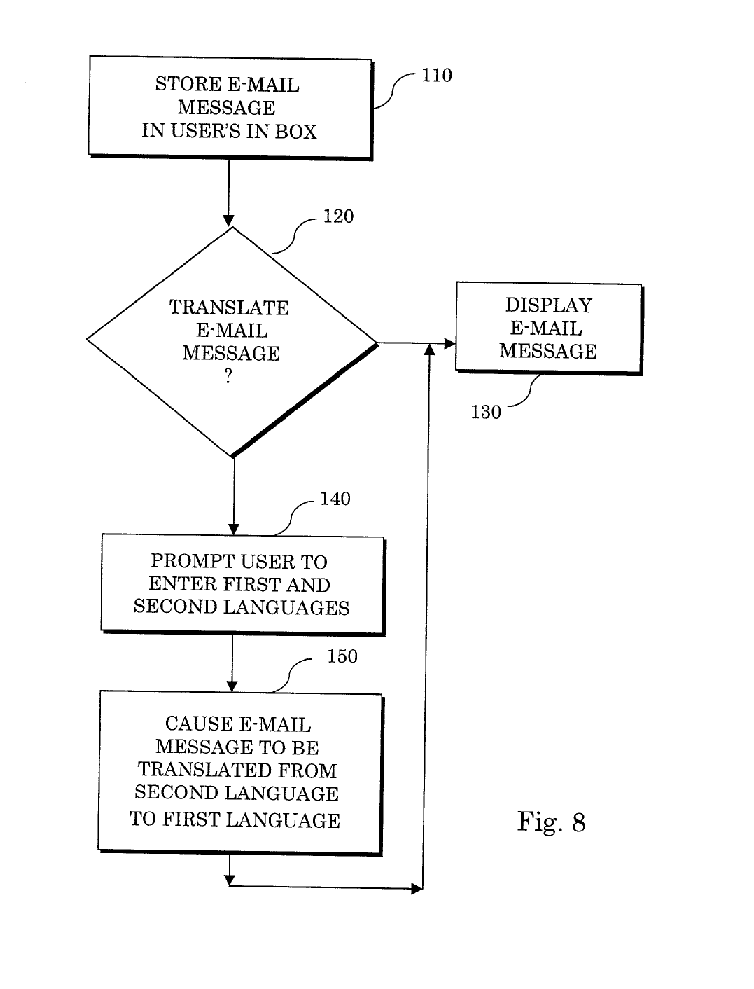

Referring now to FIG. 8, when an e-mail message is received at the computer 10 via, for example, the network 18 and the e-mail program 14 does not include data fields for storing the user/correspondent language information, the e-mail program 14 may cause the CPU 12 to perform the method illustrated by the flow chart of FIG. 8. More particularly, after an e-mail message is received by the e-mail program 14, the e-mail program 14 causes the e-mail message to be stored in the user's e-mail inbox (step 10). When the e-mail message is selected by the user for display, the e-mail program 14 prompts the user to indicate whether translation is desired (step 120) by generating, for example, the dialog window 82 of FIG. 5. If the user selects the second button 86 of the dialog window 82 indicating that translation is not desired, then the e-mail program 14 causes the e-mail message to be displayed in an untranslated state (step 130). If instead the user selects the first button 84 of the dialog window 82 indicating that translation is desired, then the e-mail program 14 prompts the user to enter a first language in which the e-mail message is written and a second language to which the e-mail message shall be translated (step 140). Referring again to FIG. 7, for example, the e-mail program 14 may prompt the user by generating the dialog window 94 having two data entry fields 96, 98 as described above. After the user enters the languages at the dialog window 94, the e-mail program 14 causes the e-mail message to be translated in the manner specified (step 150) and the translated e-mail message is then displayed for viewing (step 130).

The e-mail program 14 may further include a user selectable feature accessible via, for example, a pull-down menu that enables translation of an e-mail message that has already been selected by the user for display. Upon selecting the feature, the e-mail program 14 may prompt the user to specify which e-mail message is to be translated and may further prompt the user to specify a first and second language by displaying, for example, the dialog window 94 of FIG. 7. After entry of the first and second languages the e-mail program 14 causes the e-mail message to be translated between the first and second languages.

From the foregoing description, it should be understood that a method and apparatus that enable language translation of electronic mail messages have been shown and described, both of which have many desirable attributes and advantages. In particular, the method and apparatus enable an automatic or user-selected language translation feature integrated with an electronic mail program. Thus, e-mail messages transmitted in a foreign language become understandable to a user or correspondent without need to launch a separate language translation computer program and without need to enlist the services of a person with language translation skills.

While various embodiments of the present invention have been shown and described, it should be understood that other modifications, substitutions and alternatives are apparent to one of ordinary skill in the art. For example, as described herein, the e-mail program 14 may automatically cause an e-mail message to be translated if the language spoken by the user and the correspondent are different. Alternatively, the e-mail program 14 may cause an e-mail message to be translated if the user specifies that translation is desired via, for example, a dialog window. Whether translation is performed automatically or only at the user's request, the e-mail program 14 may cause the e-mail message to be translated in any of a number of ways. For example, the e-mail program 14 may cause the e-mail message to be translated using language translation software that is integrated into the e-mail software program 14. Alternatively, the e-mail program 14 may cause the e-mail message to be translated by invoking a language translation software application that is either stored in the same memory as the software program or that is accessible to the computer 10 via the network 18. In yet another alternative, the e-mail program 14 may cause the message to be translated by sending the e-mail message to a web-based language translation service that is adapted to translate the e-mail message and that is adapted to forward the translated e-mail message to the designated correspondent or other person for whom the e-mail message is intended. Of course, the e-mail program 14 may be adapted to attach or otherwise insert a set of instructions into the e-mail message that are intended for the web-based translation service and that specify a first language in which the e-mail message is written and a second language into which the e-mail message shall be translated. In addition, routing information may also be inserted into the e-mail message before it is transmitted to the web-based translation service so that the web-based translation service can properly route the message after the message has been translated.

Further, portions of the methods depicted in FIGS. 3 and 4 involve accessing and searching the databases 28 and 29 to locate and retrieve information therefrom so that a comparison may be made to determine whether language translation is even necessary. As will be understood by one having ordinary skill in the art, accessing, searching and retrieving data from a database may be performed in a number of ways. For example, the e-mail program 14 may actually cause the CPU 12 to locate and retrieve the desired information by copying the desired information from the databases 28 and 29 and may then cause the information to be temporarily stored in a set of memory registers where the information may be compared. Alternatively, the CPU 12 may search the databases 28 and 29 to obtain a memory address(es) where the desired information is located and then access the memory address(es) when comparing the information.

Moreover, the method and apparatus of the present invention, although described for use in translating an e-mail message between a first language and a second language, may also be used to translate an e-mail message from the first language to any number of languages associated with any number of correspondents. Thus, for example, if the user prepares an e-mail message addressed to a plurality of correspondents, the method and apparatus may cause the e-mail message to be translated into the languages associated with each correspondent before causing each translated e-mail message to be transmitted to the appropriate correspondent. In addition, the method and apparatus of the present invention may be used to enable translation of e-mail messages generated by multiple users that each speak different languages. For example, the computer 10 may be accessible to a number of computer users each of which use and understand different languages in which case, the database 29 will include locations 45 for storing information that identifies the language of each user. Thus, to translate an e-mail message, the method and apparatus cause the CPU 12 to retrieve the information that identifies the language of the user who generated the e-mail message or to whom the e-mail message is addressed for purposes of making the comparison with the information that identifies the language of the correspondent.

Modifications, substitutions and alternatives can be made without departing from the spirit and scope of the invention, which should be determined from the appended claims.

What is claimed is:

1. A system for enabling translation of an electronic mail message between a first language associated with a user and a second language associated with a correspondent, said system comprising:
a memory device adapted to store information that identifies said first language and further adapted to store information that identifies said second language;
a processor communicatably coupled to said memory device, said processor adapted to enable electronic mail communication between said user and said correspondent, said processor further adapted to cause said electronic mail message to be translated between said first and second languages using said information that identifies said first language and said information that identifies said second language.

2. The system of claim 1 wherein said processor is communicatably coupled to a communication network and wherein said electronic mail communication between said user and said correspondent occurs via said communication network.

3. The system of claim 1 wherein said processor is further adapted to generate a language translation command, said system further comprising a language translation device communicatably coupled to said processor, said language translation device being adapted to translate said electronic mail message in response to said language translation command generated by said processor.

4. The system of claim 3 wherein said language translation device is communicatably coupled to said processor via a communication network and wherein said communication network comprises the Internet.

5. The system of claim 3 wherein said language translation device comprises software code stored in said memory that when executed by said processor translates said e-mail message.

6. The system of claim 1 wherein said processor is further adapted to compare said information that identifies said first and second languages to determine whether said first and second languages are the same, and wherein said processor causes said electronic mail message to be translated between said first language and said second language based on whether said first and second languages are the same.

7. The system of claim 1 wherein said memory device comprises first and second databases, said first database being adapted to store said information that identifies said first language and said second database being adapted to store said information that identifies said second language.

8. The system of claim 1 wherein said memory device is further adapted to store information specifying at least one of a plurality of translation modes, and further wherein said processor is further adapted to operate according to said at least one translation mode stored in said memory device.

9. The system of claim 8 wherein said plurality of translation modes comprises a mode in which said processor automatically causes said electronic mail message to be translated.

10. The system of claim 8 wherein said plurality of translation modes comprises a mode in which said processor causes said electronic mail message to be translated in response to an instruction entered by said user.

11. A system for enabling translation of an electronic mail message between a first language associated with a user and a second language associated with a correspondent, said system comprising:
a processor adapted to enable electronic mail communication between said user and said correspondent, said processor being further adapted to prompt said user to indicate whether translation of said electronic mail message between said first and second languages is desired, and said processor being further adapted to cause said electronic mail message to be translated between said first and second languages based on whether said user indicates that translation of said electronic mail message is desired.

12. The system of claim 11 further comprising:
a communication network communicatably coupled to said processor, said communication network further communicatably coupled to a plurality of network devices, said communication network being adapted to transmit said electronic mail message between said processor and said network devices.

13. The system of claim 11 wherein said processor prompts said user to indicate whether translation of said electronic mail message is desired by instructing said user to supply information that identifies said first language and to supply information that identifies said second language and wherein said processor instructs said user to supply said information that identifies said first and second languages by generating a dialog window, said dialog window including a set of data entry fields.

14. A system for enabling translation of an electronic mail message between a first language associated with a user and a second language associated with a correspondent, said system comprising:
a processor adapted to enable electronic mail communication between said user and said correspondent, said processor being further adapted to provide a language translation feature, said language translation feature being user-selectable, said processor being further adapted to cause said electronic mail message to be translated between said first and second languages in response to said language translation feature being selected; and,
a communication network communicatably coupled to said processor, said communication network being further communicatably coupled to a plurality of network devices and said communication network being adapted to transmit said electronic mail message between said processor and said network devices.

15. The system of claim 14 wherein said processor provides said language translation feature via a pull-down menu.

16. A method performed by a processor for enabling translation of an electronic mail message between a first language and a second language, said first language being associated with a user and said second language being associated with a correspondent, said method comprising the steps of:
searching a memory device communicatably coupled to said processor to determine whether said memory contains information that identifies said first language and information that identifies said second language;
comparing said information that identifies said first language to said information that identifies said second language to determine whether said first and second languages are the same based on said step of searching; and,
causing said electronic mail message to be translated between said first and second languages based on said step of comparing.

17. The method of claim 16 further comprising the step of:
storing said information that identifies said first language in said memory device and storing said information that identifies said second language in said memory device before said step of searching is performed.

18. The method of claim 16 wherein said step of causing said electronic mail message to be translated comprises the steps of:
modifying said electronic mail message to include instructions for translating said electronic mail message; and,
transmitting said electronic mail message to a translation service via a communication network coupled to said processor, said translation service translating said electronic mail message according to said instructions included with said electronic mail message.

19. The method of claim 18 wherein said communication network comprises the Internet.

20. The method of claim 18 wherein said memory comprises first and second databases, and wherein said step of storing comprises the steps of:
storing said information that identifies said first language in said first database; and,
storing said information that identifies said second language in said second database.

21. A method performed by a processor for enabling translation of an electronic mail message between a first language and a second language, said first language being associated with a user and said second language being associated with a correspondent, said method comprising the steps of:
prompting said user to indicate whether language translation of said electronic mail message is desired; and,
causing said electronic mail message to be translated if said user responds to said prompt by indicating that language translation of said electronic mail message is desired.

22. The method of claim 21 wherein said step of prompting said user to indicate whether language translation is desired comprises the step of:
prompting said user to identify said first language and said second language.

23. The method of claim 21 wherein said step of prompting said user to indicate whether said language translation is desired is performed in response to said user instructing said processor to transmit said electronic mail message to said correspondent.

24. The method of claim 21 further comprising the step of:
receiving said electronic mail message from a communication network coupled to said processor and wherein said step of prompting said user to indicate whether said language translation is desired is performed in response to said electronic mail message being received by said processor.

25. The method of claim 21 wherein said step of prompting said user to indicate whether said language translation is desired is performed in response to an instruction to display said electronic mail message, wherein said instruction is generated by said user.

26. A computer program product comprising a computer usable medium having computer readable program code embodied in said medium that when executed causes a computer to:
search a memory device communicatably coupled to said computer for information that identifies a first language and for information that identifies a second language;
compare said information that identifies said first language to said information that identifies said second language to determine whether said first and second languages are the same; and,
cause said electronic mail message to be translated between said first and second languages based on said comparison between said information that identifies said first language and said information that identifies said second language.

27. A computer program product comprising a computer usable medium having computer readable program code embodied in said medium that when executed causes a computer to:
prompt a user to indicate whether language translation of an electronic mail message is desired; and
cause said electronic mail message to be translated between a first language associated with said user and a second language associated with a correspondent if said user indicates that language translation is desired.

28. The computer program product of claim 27 wherein said computer readable program code causes said computer to prompt said user to indicate whether language translation is desired by causing said computer to prompt said user to identify said first language and said second language.

29. The computer program product of claim 27 wherein said computer readable program code causes said computer to prompt said user to indicate whether language translation is desired by causing said computer to prompt said user to identify said second language, and wherein said computer readable program code further causes a computer to search a memory device communicatably coupled to said computer for information that identifies said first language.

30. A computer program product comprising a computer usable medium having computer readable program code embodied in said medium that when executed causes a computer to:
provide a language translation feature, said language translation feature being selectable by a user;
cause an electronic mail message to be translated between a first language associated with said user and a second language associated with a correspondent in response to said language translation feature being selected.

31. The computer program product of claim 30 wherein said computer provides said language translation feature via a pull-down menu.
